(19) United States
(12) Patent Application Publication
(10) Pub. No.: US 2021/0348970 A1
(43) Pub. Date: Nov. 11, 2021

(54) DEFORMATION-INSENSITIVE BRAGG GRATING TEMPERATURE SENSOR

(71) Applicant: COMMISSARIAT A L'ENERGIE ATOMIQUE ET AUX ENERGIES ALTERNATIVES, Paris (FR)

(72) Inventors: Nicolas ROUSSEL, Paris (FR); Romain COTILLARD, Bazoches Sur Guyonne (FR); Guillaume LAFFONT, Meudon (FR)

(73) Assignee: COMMISSARIAT A L'ENERGIE ATOMIQUE ET AUX ENERGIES ALTERNATIVES, Paris (FR)

(21) Appl. No.: 17/283,190

(22) PCT Filed: Oct. 3, 2019
(86) PCT No.: PCT/FR2019/052342

§ 371 Date: Apr. 6, 2021

(30) Foreign Application Priority Data
Oct. 8, 2018 (FR) 18 59319

(51) Int. Cl. G01K 11/3206; G01B 11/16; G02B 6/02

(52) U.S. Cl. CPC G01K 11/3206; G01B 11/165; G02B 6/02347; G02B 6/02147; G02B 6/021

(57) ABSTRACT

A Bragg grating temperature sensor includes an optical fiber including a core, an optical cladding surrounding the core and a Bragg grating incorporated in the core and extending along a sensitive segment of the optical fiber. The core of the temperature sensor includes a core gap extending along a core gap segment of the optical fiber, the core gap segment being located in the vicinity of the sensitive segment. The optical cladding includes a cladding gap extending along a cladding gap segment of the optical fiber, the cladding gap segment including the sensitive segment.

### TECHNICAL FIELD

The invention relates to the field of temperature sensors and, more specifically, in the field of optical fibre Bragg grating temperature sensors. It relates to such a temperature sensor, a method for manufacturing this temperature sensor, a temperature and deformation sensor comprising such a sensor, and a measurement unit comprising this temperature sensor.

The invention is particularly useful in structural health monitoring applications, the temperature sensor being capable of being integrated on the surface of a structure to be monitored, or even within this structure.

### PRIOR ART

Structural health monitoring consists of measuring thermal and/or mechanical stress applied to a structure and inferring a status of this structure therefrom, particularly the presence of damage. Optical fibre Bragg grating sensors are particularly suitable for making these measurements. They make it possible to supply temperature and deformation measurements both in static or quasi-static mode and in dynamic mode. It is particularly possible to make vibratory measurements, acceleration measurements or detect acoustic waves. The data collected can then be processed to detect and characterise the presence of damage in the structure. Furthermore, the same optical fibre sensor can include several Bragg gratings acting in differentiated wavelength bands and thus supplying as many sensing elements for the same optical fibre, these elements being individually addressable by spectral multiplexing. Individual addressing is also possible by temporal multiplexing or by both spectral and temporal multiplexing. It is then furthermore possible to locate damage in the structure. A problem associated with Bragg grating sensors is that they are sensitive to length variations of the Bragg gratings thereof independently of the thermal or mechanical origin of these length variations. Thus, for a given Bragg grating, the variation of its length, measured by variation of the Bragg wavelength, does not make it possible to directly determine a temperature variation or a deformation variation of purely mechanical origin.

A solution for separating measurements of deformation of mechanical origin from those of thermal origin has particularly been proposed in M. Song, S. B. Lee, S. S. Choi and B. Lee, “Simultaneous Measurement of Temperature and Strain Using Two Fiber Bragg Gratings Embedded in a Glass Tube”, Optical Fiber Technology 3, p. 194-196, 1997. The principle is based on the use of two Bragg gratings with assumed identical characteristics on the same fibre. A first Bragg grating is simultaneously subjected to two sources of external stress: temperature and deformation. A second Bragg grating, positioned at the optical fibre end, is mechanically isolated by introducing the optical fibre end into a capillary tube. The optical fibre, only being attached on one side, is mechanically free and will therefore only be sensitive to temperature variations. Solving a system of two equations with two unknowns then makes it possible to determine each of the unknowns, namely the temperature variation and the stress variation. A drawback of this solution is that the sensor has a size greater than that of the optical fibre, which may complicate its integration in a structure. A further drawback is that the spatial resolution is limited by the presence of two serial Bragg gratings for a single measurement point. The solution has the further drawback of being incompatible with multiplexing, insofar as the optical fibre containing the Bragg grating assigned to the temperature measurement is cut at the end to be enclosed in a capillary tube.

It has also been proposed to measure temperatures using optical fibres having a long-period grating (LPG). These optical fibres are for example described in A. M. Vengsarkar, P. J. Lemaire, J. B. Judkins, V. Bathia, T. Erdogan and J. E. Sipe, “Long-period fiber gratings as band-rejection filters”, Journal of Lightwave technology, p. 58-65, 1996 and in V. Bathia and A. M. Vengsarkar, “Optical fiber long-period grating sensors”, Optics Letters, P. 692-694, 1996. They have useful properties for decoupling since, on one hand, they are around two times less sensitive to deformation and five times more sensitive to temperature variations than a conventional Bragg grating optical fibre. Thus, an LPG optical fibre can have a sensitivity to deformation of 0.5 pm/μc (picometre per με, where με denotes a variation of the length of the optical fibre, in micrometres per meter) and 60 pm/° C. (picometre per degree Celsius). Combinations of several LPG optical fibres or of an LPG optical fibre with a conventional Bragg grating optical fibre make it possible to obtain a decoupling of the thermal and mechanical effects. The document B. H. Lee, Y. Chung, W. T. Han and U. C. Paek, “Temperature sensor based on self-interference of a single long-period fiber grating”, IEICE Transactions on Electronics, p. 287-292, 2000 describes an example of such a combination resulting in a sensor wherein the thermal sensitivity is 55 pm/° C. with an error of 0.2° C. A drawback of these sensors based on a long-period grating is that the spectrum can only be processed in transmission. Furthermore, the peak of the spectrum is relatively wide, which can pose detection problems. Finally, the long-period grating extends over a length of 10 to 50 MM, i.e. a markedly greater length than that of a Bragg grating. The measurement resolution is therefore limited.

A further solution proposed in G. P. Brady, K. Kalli, D. J. Webb, D. A. Jackson, L. Reekie and J. L. Archambault, “Simultaneous measurement of strain and temperature using the first and second-order diffraction wavelengths of Bragg gratings”, IEE Proceedings-Optoelectronics, p. 156-161, 1997, is based on observing the multiple orders of diffraction of a single Bragg grating, the sensitivities being assumed to be distinct for each order of diffraction. It is then theoretically possible to obtain an independent equation system for a single Bragg grating. However, the temperature and deformation measurement uncertainties are relatively substantial, of the order of 0.7° C. and 25με (micrometres per metre).

It has furthermore been proposed in M. G. Xu, J. L. Arcambault, L. Reekie and J. P. Dakin, “Discrimination between strain and temperature effects using dual-wavelength fibre grating sensors”, Electronics Letters, p. 1085-1087, 1994 to incorporate at the same location of the optical fibre two Bragg gratings having distinct Bragg wavelengths. This solution makes it possible to obtain a good spatial resolution. However, the measurement uncertainties are substantial, of the order of 5° C. and 10με.

The solutions cited above for measuring a temperature and a deformation using an optical fibre sensors are therefore not fully satisfactory. An aim of the invention is therefore that of proposing an optical fibre sensor making it possible to measure at least one temperature simply and reliably. A further aim of the invention is that of providing an optical fibre sensor, the design, production and maintenance costs of which are compatible with industrial-scale use.

### DESCRIPTION OF THE INVENTION

For this purpose, the invention is based on a machining of an optical fibre comprising a Bragg grating, the machining being arranged to isolate the Bragg grating from the propagation of mechanical stress sustained by the optical fibre. The Bragg grating then only retains temperature sensitivity.

More specifically, the invention relates to a Bragg grating temperature sensor comprising an optical fibre including a core, an optical cladding surrounding the core and a Bragg grating incorporated in the core and extending along a segment of the optical fibre called sensitive segment. According to the invention, the core includes a core gap extending along a segment of the optical fibre called core gap segment, the core gap segment being located in the vicinity of the sensitive segment, and the optical cladding includes a cladding gap extending along a segment of the optical fibre called cladding gap segment, the cladding gap segment including the sensitive segment.

The optical fibre can be a solid-core optical fibre, i.e. an optical fibre wherein the core is formed from a material, typically silica. The silica can optionally be doped in order to adapt the refractive index thereof and/or the optical and/or mechanical properties thereof.

According to the invention, a core gap along a core gap segment is understood as an absence of material forming the core along this segment. The core gap thus generates a void, a gap or a break at the optical fibre core, over the entire cross-section of the core and the entire length of the core gap segment. The core gap has the effect of preventing the propagation of mechanical stress between the two core segments separated by this core gap.

The vicinity of the sensitive segment is understood as the area located close to this segment. It is for example delimited by a distance equal to the length of the Bragg grating (length typically of the order of one millimetre, the spectral width of the Bragg grating being inversely proportional to the length thereof).

A cladding gap along a cladding gap segment is understood as an absence of the material—or optionally the materials—forming the optical cladding over at least an annular portion surrounding the core and extending along this segment. The cladding gap can extend radially over the entire cross-section of the optical cladding. The cladding gap thus generates a void, a gap or a break at the optical cladding, over all or part of the cross-section of the optical cladding and the entire length of the cladding gap segment. The cladding gap has the effect of preventing the propagation of mechanical stress between the two optical cladding segments separated by this cladding gap and between the portion of the core comprising the Bragg grating and a mechanical cladding surrounding the optical cladding.

The optical fibre can include a plurality of Bragg gratings incorporated in the core and each extending along a sensitive segment. The core can then include, for each Bragg grating, a core gap extending along a core gap segment in the vicinity of the corresponding sensitive segment. Similarly, the optical cladding can then include, for each Bragg grating, a cladding gap extending along a cladding gap segment including the corresponding sensitive segment.

The invention also relates to a method for manufacturing a Bragg grating temperature sensor from an optical fibre including a core, an optical cladding surrounding the core and a Bragg grating incorporated in the core and extending along a segment of the optical fibre called sensitive segment. According to the invention, the method comprises a step of ablating the core along a segment of the optical fibre called core gap segment, the core gap segment being located in the vicinity of the sensitive segment. The method further comprises a step of ablating the optical cladding along a segment of the optical fibre called cladding gap segment, the cladding gap segment including the sensitive segment.

The optical fibre can include a plurality of Bragg gratings incorporated in the core and each extending along a sensitive segment. The step of ablating the core then includes, for each Bragg grating, ablating the core along a core gap segment in the vicinity of the corresponding sensitive segment. The step of ablating the optical cladding then includes, for each Bragg grating, ablating the optical cladding along a cladding gap segment including the corresponding sensitive segment.

The step of ablating the core can comprise an application of a femtosecond laser beam focused in the vicinity of the core. Preferably, the focusing is located in the core. In an equivalent manner, the step of ablating the optical cladding can comprise an application of a femtosecond laser beam focused in the vicinity of the optical cladding. Preferably, the focusing is located in the optical cladding. It should be noted that, during the step of ablating the optical cladding, touching the core of the optical fibre and, more particularly, the patterns of the Bragg grating should be avoided. In other words, material must only be removed at the optical cladding. Due to the annular shape of the cladding gap, the optical fibre can be rotated about the longitudinal axis thereof during the step of ablating the optical cladding.

In order to prevent a transmission of stress, via the optical cladding, between the two core segments separated by the core gap, each cladding gap segment preferably includes, in addition to a sensitive segment, the corresponding core gap segment. In other words, a removal of material is performed in the optical cladding both on the sensitive segment wherein a Bragg grating is incorporated and along the core gap segment. Thus, along the core gap segment, the material is removed over the entire cross-section of the core and at least over an annular portion of the optical cladding surrounding the core.

The temperature sensor and the manufacturing method according to the invention can also be characterised by the following features.

The core gap segment must have the shortest possible length to minimise guided mode energy losses in the optical fibre core. The core gap segment extends for example along a length less than or equal to a few micrometres, preferably less than or equal to 1 μm (micrometre). Thus, an optical coupling is established between the two core segments separated by the core gap.

The optical fibre can be microstructured. In particular, the optical cladding of the optical fibre can be microstructured, i.e. it comprises structures on a micrometric scale having a different refractive index from the rest of the optical cladding. In particular, the optical cladding can comprise optionally doped silica rods and/or hollow channels. These structures can particularly be arranged periodically in a transverse plane of the optical fibre.

According to a first embodiment, the optical fibre is a suspended-core optical fibre. The optical cladding comprises an inner ring surrounding the core and an outer ring surrounding the inner ring, the inner ring including a plurality of hollow channels extending longitudinally in the optical fibre and forming walls connecting the core to the outer ring. The hollow channels have preferably identical dimensions, such that the optical fibre retains an axial symmetry. The inner ring includes at least two hollow channels. In this case, the hollow channels have preferably an oblong shape in a transverse plane of the optical fibre so as to form a thin wall passing through the core of the optical fibre. The inner ring can include more than two hollow channels, in particular three or four. The hollow channels are then advantageously homogeneously angularly distributed. By way of example, for an optical cladding including three hollow channels, the hollow channels are advantageously disposed so as to form three walls separated from one another by an angle of 120 degrees in a transverse plane of the optical fibre.

According to a second embodiment, the optical fibre is a photonic crystal optical fibre. The optical cladding comprises a plurality of hollow channels extending longitudinally into the optical fibre and being arranged periodically in a transverse plane of the optical fibre. The hollow channels have preferably identical dimensions, such that the optical fibre retains an axial symmetry. They can occupy the entire cross-section of the optical cladding or merely a portion. In particular, the optical cladding can include an inner ring surrounding the core and an outer ring surrounding the inner ring. The hollow channels can then be disposed in the inner ring only.

The Bragg grating temperature sensor described above is arranged so that the Bragg grating(s) are not subject to deformations of mechanical origin and are only sensitive to temperature variations. Nevertheless, it is possible to not mechanically isolate all of the Bragg gratings of the optical fibre, so that some Bragg gratings remain sensitive both to deformations of mechanical origin and to deformations of thermal origin. Thus, the invention further relates to a Bragg grating temperature and deformation sensor comprising a temperature sensor as described above, and wherein the optical fibre further includes at least one Bragg grating incorporated in the core and extending along a segment of the optical fibre called mechanically sensitive segment, the core being devoid of a core gap in the vicinity of the mechanically sensitive segment and the optical cladding being devoid of a cladding gap in the vicinity of the mechanically sensitive segment.

The Bragg grating temperature and deformation sensor described above includes a plurality of Bragg gratings incorporated in the core of the same optical fibre, a first type of Bragg grating being sensitive both to deformations of mechanical origin and to deformations of thermal origin and a second type of Bragg grating only being sensitive to deformations of thermal origin. Nevertheless, all the Bragg gratings of the first type can be incorporated in a first optical fibre and all the Bragg gratings of the second type can be incorporated in a second optical fibre. Thus, the invention also relates to a measurement unit including a Bragg grating temperature sensor as described above and a Bragg grating temperature and deformation sensor. The temperature and deformation sensor comprises a second optical fibre including a core, an optical cladding surrounding the core and at least one Bragg grating incorporated in the core. In the temperature and deformation sensor, the core is devoid of a core gap in the vicinity of the segment wherein the Bragg grating is incorporated, called mechanically sensitive segment, and the optical cladding is devoid of a cladding gap in the vicinity of the mechanically sensitive segment. Preferably, the optical fibres of the two sensors are associated in parallel such that each sensitive segment of the optical fibre of the temperature sensor is adjacent to a mechanically sensitive segment of the second optical fibre of the temperature and deformation sensors.

### BRIEF DESCRIPTION OF THE DRAWINGS

Further features, details and advantages of the invention will emerge on reading the following description, given merely by way of non-limiting example and with reference to the appended drawings wherein:

FIG. 1 represents an example of a method for manufacturing a Bragg grating sensor according to the invention from a suspended-core optical fibre;

FIG. 2A represents, in a perspective view with a partial cross-section, an example of suspended-core optical fibre capable of being used to embody a temperature sensor according to the invention;

FIG. 2B represents, in an identical view to that in FIG. 2A, the optical fibre following a step of incorporating a Bragg grating;

FIG. 2C represents, in an identical view to those in FIGS. 2A and 2B, the optical fibre following a step of ablating the core;

FIG. 2D represents, in an identical view to those in FIGS. 2A to 2C, the optical fibre following a step of ablating the optical cladding;

FIG. 3 represents, in a graph, the sensitivity to deformation of a standard Bragg grating sensors and that of an example of Bragg grating sensor according to the invention;

FIG. 4A represents, in a perspective view with a partial cross-section, an example of photonic crystal optical fibre capable of being used to embody a temperature sensor according to the invention;

FIG. 4B represents, in an identical view to that in FIG. 4A, the temperature sensor obtained by applying the manufacturing method according to the invention.

### DETAILED DESCRIPTION OF SPECIFIC EMBODIMENTS

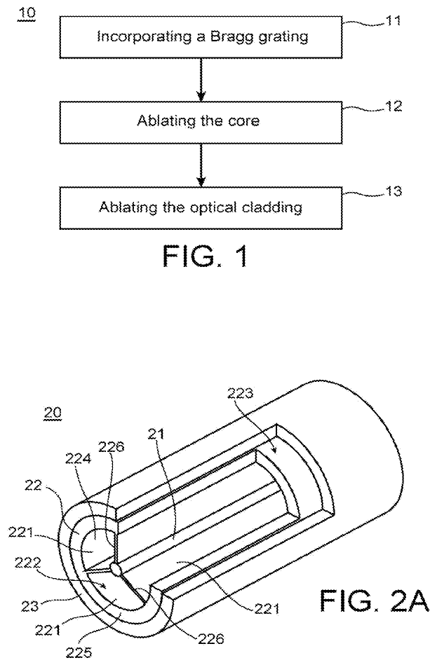

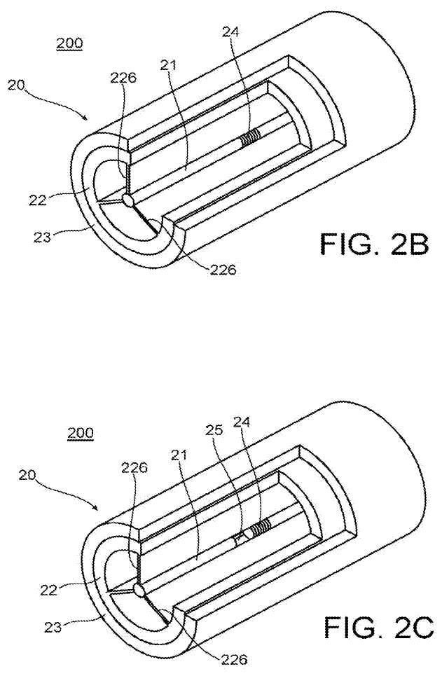

FIG. 1 represents an example of a method for manufacturing a Bragg grating sensor according to the invention from a suspended-core optical fibre. FIG. 2A represents, in a perspective view with a partial cross-section, an example of a suspended-core optical fibre 20 from which the manufacturing method 10 can be implemented and FIGS. 2B to 2D illustrate the optical fibre 20 following different steps of this manufacturing method. The optical fibre 20 includes a core 21, an optical cladding 22 surrounding the core 21 and a mechanical cladding 23 surrounding the optical cladding 22. The core 21 is formed from a silica glass. It can be doped in order to modify the refractive index thereof and/or the mechanical properties thereof. It has a revolving cylindrical shape about a longitudinal axis of the optical fibre 20. The optical cladding 22 includes three hollow channels 221, an intermediate surface 222 and an outer surface 223. The outer surface 223 comes into contact with the mechanical cladding 23. The intermediate surface 222 is cylindrical of revolution, centred on the longitudinal axis of the optical fibre 20 and located between the core 21 and the outer surface 223. It defines for the optical cladding 22 an inner ring 224, comprised between the core 21 and this intermediate surface 222, and an outer ring 225, comprised between this intermediate surface 222 and the outer surface 223. Each hollow channel 221 extends longitudinally in the optical fibre 20 and extends radially in the entire inner ring 224, i.e. between the core 21 and the intermediate surface 222. Each hollow channel 221 covers an angular cross-section approximately equal to 120′, so as to form walls 226 extending radially between the core 21 and the intermediate surface 222. The core 21 is thus suspended from the outer ring 225 of the optical cladding 22 via the walls 226. The walls 226 and the outer ring 225 form a one-piece part comprising silica glass. As a general rule, prior to applying the steps of the manufacturing method 10 of a Bragg grating sensor, the optical fibre 20 has a continuous nature along the longitudinal axis thereof.

The manufacturing method 10 comprises a first step 11 of incorporating one or more Bragg gratings 24 in the core 21 of the optical fibre. Each Bragg grating 24 extends along the longitudinal axis of the optical fibre 20 along a segment called sensitive segment. FIG. 2B represents, in an identical view to that in FIG. 2A, the optical fibre 20 following this step 11. The optical fibre is then also called Bragg grating sensor 200. It should be noted that the Bragg grating 24 is represented schematically by disks extending over the entire cross-section of the core 21. Nevertheless, the Bragg grating sensor according to the invention is not limited to a Bragg grating having patterns in disk form, but is applicable to any type of Bragg grating, particularly to a Bragg grating wherein the patterns are formed by spheres. Moreover, the Bragg grating can include any number of patterns.

The manufacturing method 10 then comprises a second step 12 of ablating the core 21. FIG. 2C represents, in an identical view to that in FIGS. 2A and 2B, the optical fibre 20 following this step 12. Ablating the core 21 consists of removing the core 21 along a segment, called core gap segment, located in the vicinity of the sensitive segment, i.e. in the vicinity of the Bragg grating 24. The core gap segment can be adjoined to the sensitive segment. Nevertheless, in order to prevent damage of the pattern located at the end of the Bragg grating 24, the core gap segment is advantageously offset, for example by a distance corresponding to the wavelength of the Bragg grating 24. The portion removed from the core 21 is called the core gap 25. The core gap segment has for example a length equal to 1 μm. The length must be sufficiently reduced to enable a usable light signal to cross the core gap 25.

The manufacturing method then comprises a third step 13 of ablating the optical cladding 22. FIG. 2D represents, in an identical view to that in FIGS. 2A to 2C, the optical fibre 20 following this step 13. Ablating the optical cladding 22 consists of removing the walls 226 of the optical cladding 22 along a segment, called cladding gap segment, including at least the sensitive segment. In the present embodiment example, the cladding gap segment covers both the sensitive segments and the core gap segment. The portion removed from the optical cladding 22 is called cladding gap 26.

The ablation of the core 21 and the optical cladding 22 can be carried out by applying a femtosecond laser beam in the near infrared or in the ultraviolet range. A femtosecond laser beam is a laser beam formed of pulses, the duration whereof is between a few femtoseconds and a few hundred femtoseconds. The laser beam is focused on the zone to be removed. The pulse power is adapted according to the numerical aperture of the beam. During the ablation steps, the optical fibre 20 can be set in rotation and/or in translation. Rotation facilitates the removal of the walls 226 around the core 21.

It should be noted that the steps of the manufacturing method 10 can be carried out in any order. In particular, the Bragg grating(s) can be incorporated after ablating the core and the optical cladding. Moreover, the ablation of the optical cladding can be carried out prior to that of the core.

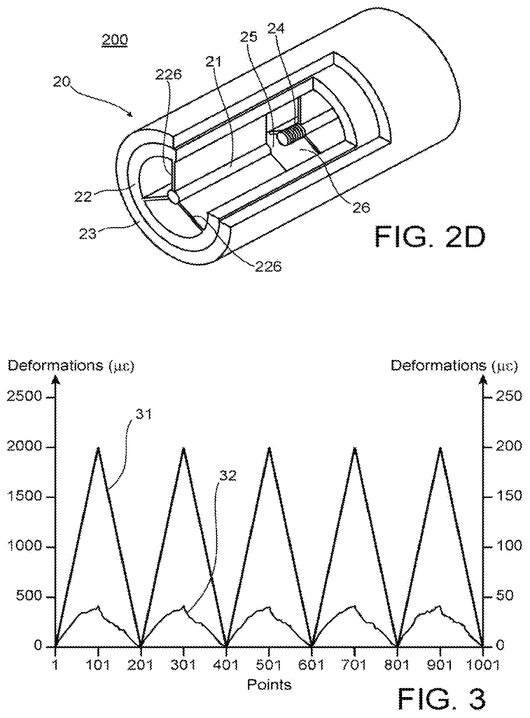

FIG. 3 represents, in a graph, the sensitivity to deformation of a standard Bragg grating sensors and that of a Bragg grating sensor according to the invention. The two sensors are made from the same hollow-core optical fibre by incorporating in the core two Bragg gratings having Bragg wavelengths of 1510 nm and 1550 nm, respectively. The 1550 nm Bragg grating is mechanically isolated from the rest of the optical fibre by ablating the core and ablating the optical cladding, according to the method according to the invention. The 1510 nm Bragg grating is not mechanically isolated from the rest of the optical fibre. The sensitivity to deformation of the two Bragg gratings is determined by measuring a spectral offset of each of the Bragg wavelengths during a deformation of the optical fibre by stretching along the longitudinal axis thereof. The stretching applied comprises a cycle of constant increases and decreases. In the graph, the x-axis indicates different measurement points, corresponding to different stretching amplitudes, and the y-axis indicates the deformation of the optical fibre, in micrometres per metre, this deformation being determined by each Bragg grating based on the offset of the wavelength thereof. A first curve 31 represents the deformation of the optical fibre determined by the Bragg grating not mechanically isolated and a second curve 32 represents the deformation of the optical fibre determined by the mechanically isolated Bragg grating. The first curve indicates a maximum deformation of 2000με and the second curve indicates a maximum deformation of 40με. Thus, the mechanical isolation of the Bragg grating makes it possible to reduce the sensitivity to deformation of this Bragg grating by a factor of 50.

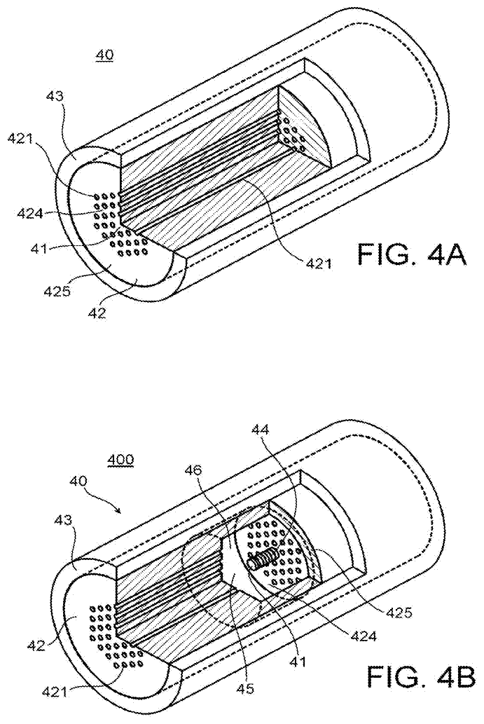

FIG. 4A represents, in a perspective view with a partial cross-section, an example of a photonic crystal optical fibre from which the manufacturing method can be implemented and FIG. 4B represents, in an identical view, an example of Bragg grating sensor obtained by applying the method to the optical fibre in FIG. 4A. The optical fibre 40 includes a core 41, an optical cladding 42 surrounding the core 41 and a mechanical cladding 43 surrounding the optical cladding 42. The optical cladding 42 comprises a set of hollow channels 421 arranged periodically in a transverse plane of the optical fibre 40. The hollow channels 421 have a revolving cylinder shape and extend parallel with a longitudinal axis of the optical fibre 40. The optical cladding 42 can be fictitiously delimited radially by an inner ring 424 and an outer ring 425. All the hollow channels 421 are disposed in the inner ring 424 of the optical cladding 42, the outer ring 425 being devoid of such microstructures. The core 41 is optically formed at the centre of the grating of hollow channels 421. It should be noted that the optical fibre 40 has a material continuity between the core 41 and the inner ring 424 of the optical cladding 42, in the same way as between the inner ring 424 and the outer ring 425 of the optical cladding 42. The core 41 and the optical cladding 42 are for example formed of silica glass, optionally doped. Like the optical fibre 20 represented in FIG. 2A, the optical fibre 40 has, prior to applying the steps of the manufacturing method according to the invention, a continuous nature along the longitudinal axis thereof.

In FIG. 4B, the optical fibre 40 is represented after applying the steps of the manufacturing method according to the invention. It is then also called Bragg grating sensor 400. The Bragg grating sensor 400 comprises a Bragg grating 44 incorporated in the core 41 and extending along a sensitive segment, a core gap 45 extending over a core gap segment extending in the vicinity of the sensitive segment and a cladding gap 46 extending along a cladding gap segment encompassing the sensitive segment and the core gap segment. In this embodiment example, the core 41 is presented in the form of a revolving cylinder along the sensitive segment. The core gap segment has for example a length equal to 1 μm. It should be highlighted that, with a view to facilitating the comprehension of the invention, the proportions of the different elements of the Bragg grating sensor are not necessarily observed. In particular, the length of the core gap segment is preferably less than that represented in FIG. 4B.

The present invention has been described above with reference to Bragg grating sensors comprising a suspended-core optical fibre or a photonic crystal optical fibre. Nevertheless, the invention is found to be applicable to any Bragg grating optical fibre once it is possible to extract from the optical fibre the material removed from the core and the optical cladding. Moreover, the same optical fibre can include both one or more first Bragg gratings mechanically isolated by the presence of a core gap and a cladding gap according to the invention, and one or more second Bragg gratings not mechanically isolated. The first Bragg gratings are then used as elements sensitive only to temperature and the second Bragg gratings are used as elements sensitive to temperature and deformation. The Bragg grating sensor can thus be called a Bragg grating temperature and deformation sensor.

1. A Bragg grating temperature sensor comprising: an optical fiber including a core, an optical cladding surrounding the core and a Bragg grating incorporated in the core and extending along a segment of the optical fiber called sensitive segment, wherein the core includes a core gap extending along a segment of the optical fiber called core gap segment, the core gap segment being located in the vicinity of the sensitive segment, and wherein the optical cladding includes a cladding gap extending along a segment of the optical fiber called cladding gap segment, the cladding gap segment including the sensitive segment.

2. The sensor according to claim 1, wherein the optical fiber includes a plurality of Bragg gratings incorporated in the core and each extending along a sensitive segment, the core including, for each Bragg grating, a core gap extending along a core gap segment in the vicinity of the corresponding sensitive segment, the optical cladding including, for each Bragg grating, a cladding gap extending along a cladding gap segment including the corresponding sensitive segment.

3. A method for manufacturing a Bragg grating temperature sensor from an optical fiber including a core, an optical cladding surrounding the core and a Bragg grating incorporated in the core and extending along a segment of the optical fiber called sensitive segment, the method comprising a step of ablating the core along a segment of the optical fiber called core gap segment, the core gap segment being located in the vicinity of the sensitive segment, and a step of ablating the optical cladding along a segment of the optical fiber called cladding gap segment, the cladding gap segment including the sensitive segment.

4. The method according to claim 3, wherein the optical fiber includes a plurality of Bragg gratings incorporated in the core and each extending along a sensitive segment, the step of ablating the core comprising, for each Bragg grating, ablating the core along a core gap segment in the vicinity of the corresponding sensitive segment, the step of ablating the optical cladding comprising, for each Bragg grating, ablating the optical cladding along a cladding gap segment including the corresponding sensitive segment.

5. The method according to claim 3, wherein the step of ablating the core comprises an application of a femtosecond laser beam focused in the vicinity of the core, and/or the step of ablating the optical cladding comprises an application of a femtosecond laser beam focused in the vicinity of the optical cladding.

6. The sensor according to claim 1, wherein each cladding gap segment includes, in addition to a sensitive segment, the corresponding core gap segment.

7. The sensor according to claim 1, wherein the core gap segment extends over a length less than or equal to 10 micrometers.

8. The sensor according to claim 1, wherein the optical cladding is microstructured.

9. The sensor according to claim 8, wherein the optical fiber is a suspended-core optical fiber, the optical cladding comprising an inner ring surrounding the core and an outer ring surrounding the inner ring, the inner ring including a plurality of hollow channels extending longitudinally in the optical fiber and forming walls connecting the core to the outer ring.

10. The sensor according to claim 8, wherein the optical fiber is a photonic crystal optical fiber, the optical cladding comprising a plurality of hollow channels extending longitudinally in the optical fiber and being arranged periodically in a transverse plane of the optical fiber.

11. A Bragg grating temperature and deformation sensor comprising: a temperature sensor according to claim 1, wherein the optical fiber further includes at least one Bragg grating incorporated in the core and extending along a segment of the optical fiber called mechanically sensitive segment, the core being devoid of a core gap in the vicinity of the mechanically sensitive segment and the optical cladding being devoid of a cladding gap in the vicinity of the mechanical sensitive segment.

12. A measurement unit including a Bragg grating temperature sensor according to claim 1 and a Bragg grating temperature and deformation sensor, the temperature and deformation sensor comprising a second optical fiber including a core, an optical cladding surrounding the core and at least one Bragg grating incorporated in the core.

13. The manufacturing method according to claim 3, wherein each cladding gap segment includes, in addition to a sensitive segment, the corresponding core gap segment.

14. The manufacturing method according to claim 3, wherein the core gap segment extends over a length less than or equal to 10 micrometers.

15. The manufacturing method according to claim 3, wherein the optical cladding is microstructured.

16. The manufacturing method according to claim 15, wherein the optical fiber is a suspended-core optical fiber, the optical cladding comprising an inner ring surrounding the core and an outer ring surrounding the inner ring, the inner ring including a plurality of hollow channels extending longitudinally in the optical fiber and forming walls connecting the core to the outer ring.

17. The manufacturing method according to claim 15, wherein the optical fiber is a photonic crystal optical fiber, the optical cladding comprising a plurality of hollow channels extending longitudinally in the optical fiber and being arranged periodically in a transverse plane of the optical fiber.
